(19) United States
(12) Patent Application Publication
(10) Pub. No.: US 2026/0034544 A1
(43) Pub. Date: Feb. 5, 2026

(54) MATERIALS, METHODS, AND SAMPLING DEVICES FOR PRESERVING AND EXTRACTING EXTRACELLULAR VESICLES IN BIOFLUIDS

(71) Applicant: Purdue Research Foundation, West Lafayette, IN (US)

(72) Inventors: Weiguo Tao, West Lafayette, IN (US); Yi-Kai Liu, Lafayette, IN (US)

(73) Assignee: Purdue Research Foundation, West Lafayette, IN (US)

(21) Appl. No.: 19/282,803

(22) Filed: Jul. 28, 2025

Related U.S. Application Data
(60) Provisional application No. 63/677,013, filed on Jul. 30, 2024.

(51) Int. Cl. B01L 3/00

(52) U.S. Cl. CPC B01L 3/502761; B01L 2300/04; B01L 2300/0609; B01L 2300/0681; B01L 2300/0816; B01L 2300/0851; B01L 2300/0861; B01L 2300/126

(57) ABSTRACT

A biofluid card assembly for isolating extracellular vesicles present in biofluids includes a biofluid card having a plurality of layers; and a fastener, the biofluid card includes a top lid with at least one opening configured to receive at least one biofluid sample including principal components and extracellular vesicles present therein, a biofluid separation membrane assembly disposed adjacent the top lid and configured to separate and direct the extracellular vesicles, at least one extracellular vesicle capture membrane having at least one extracellular vesicle capture agent formed thereon or embedded therein, each disposed below and adjacent the biofluid separation membrane assembly and configured to receive the extracellular vesicles, wherein each of the at least one extracellular vesicle capture agent includes a binding agent configured to bind to the extracellular vesicle having predetermined binding sites, and a bottom lid disposed adjacent the at least one extracellular vesicle capture membrane.

### CROSS-REFERENCE TO RELATED APPLICATIONS

The present non-provisional patent application is related to and claims the priority benefit of U.S. Provisional Patent Application Ser. 63/677,013, filed Jul. 30, 2024, the contents of which are hereby incorporated by reference in its entirety into the present disclosure.

### STATEMENT REGARDING GOVERNMENT FUNDING

None.

### TECHNICAL FIELD

The present disclosure generally relates to a system and method for isolating biological material, and in particular to a system and method for isolating extracellular vesicles in biofluids.

### BACKGROUND

This section introduces aspects that may help facilitate a better understanding of the disclosure. Accordingly, these statements are to be read in this light and are not to be understood as admissions about what is or is not prior art.

Extracellular vesicles are present in whole blood and because they include characteristics of original cells, e.g., blood cells, are useful for diagnosing diseases such as cancer, neurogenerative diseases, genetic disorders, as well as identifying drug uptake and metabolism. Extracellular vesicles are generally lipid particles, e.g., phospholipid biolayers, that are incapable of replication and originate from a variety of cells, carrying cargoes with important information, including proteins, post-translational modifications, deoxyribonucleic acids, ribonucleic acids, and lipids. Thus, composition of extracellular vesicles varies depending on their originating cells. Extracellular vesicles can be found in a variety of biofluids, e.g., blood, urine, and saliva. Extracellular vesicles vary in size from about 20 nm to about 10 microns and in some cases even larger.

Several state-of-the-art methods are employed in order to isolate extracellular vesicles from other things found in biofluids. The most common such prior art method includes the use of ultracentrifuges and filtering based on size difference between extracellular vesicles and other items in biofluids.

However, using either of the above methods, the extracellular vesicle isolation is limited by a variety of challenges, including yield, complicated procedures, and challenges associated with varying sizes, and thus corresponding mass for the interested extracellular vesicles.

Therefore, there is an unmet need for a novel robust system and method that can effectively isolate extracellular vesicles in biofluids and be easy to use and transport for off-site analysis, particularly in dried biofluid form, for disease diagnosis, remote monitoring, telemedicine, and precision medicine.

### SUMMARY

A biofluid card assembly for isolating extracellular vesicles present in biofluids is disclosed. The assembly includes a biofluid card having a plurality of layers, and a fastener configured to hold one or more of the plurality of layers of the biofluid card. The biofluid card includes a top lid with at least one opening formed therein configured to receive at least one biofluid sample including one or more principal components and extracellular vesicles present therein. The biofluid card further includes separation membrane assembly disposed adjacent the top lid and configured to separate and direct the extracellular vesicles. The biofluid card also includes at least one extracellular vesicle capture membrane having at least one extracellular vesicle capture agent formed thereon, each disposed below or embedded in the at least one extracellular vesicle capture membrane and corresponding to the at least one first opening and adjacent the biofluid separation membrane assembly and configured to receive the extracellular vesicles. Each of the at least one extracellular vesicle capture agent includes a binding agent configured to bind to the extracellular vesicle having predetermined binding sites. The biofluid card further includes a bottom lid disposed adjacent the at least one extracellular vesicle capture membrane.

A method for isolating extracellular vesicles present in whole blood is also disclosed. The method includes inputting a whole blood sample including one or more principal components and extracellular vesicles present therein in to a biofluid card assembly, receiving the whole blood sample via a top lid of the biofluid card assembly with at least one opening formed therein, separating the extracellular vesicles via a biofluid separation membrane assembly disposed below and corresponding to the at least one opening and configured to separate the one or more principal components of the whole blood from remaining components of the whole blood including extracellular vesicles, and capturing the extracellular vesicle via at least one extracellular vesicle capture membrane having at least one extracellular vesicle capture agent formed thereon, each disposed below or embedded in the at least one extracellular vesicle capture membrane and corresponding to the at least one opening and adjacent the biofluid separation membrane assembly on one side and adjacent a bottom lid on a second side, wherein each of the at least one extracellular vesicle capture agent includes binding agent configured to bind to the extracellular vesicle having predetermined binding sites.

### BRIEF DESCRIPTION OF FIGURES

The patent or application file contains at least one drawing executed in color. Copies of this patent or patent application publication with color drawing(s) will be provided by the Office upon request and payment of the necessary fee.

FIG. 1 and FIG. 2 are a perspective view and an exploded view, respectively, of a biofluid card assembly containing a biofluid card having at least one well and which biofluid card is encased by fasteners.

FIG. 3 provides example sizes of the different layers of the biofluid card and the fasteners shown in FIGS. 1 and 2.

FIGS. 4a, 4b, and 4c provide a sample biofluid collection and processing flowchart expanding three drawing sheets, including sample collection of biofluids including extracellular vesicles (EVs), followed by packaging the entire biofluid card assembly in which case a downstream laboratory disassembles the biofluid card assembly to gain access to the extracellular vesicle capture membrane layer, or removing all layers, except for the extracellular vesicle capture membrane and packing this layer, for later off-site or on-site processing and analysis.

FIG. 5a provides photographs showing the front, back, and blood collection view of a three-spot assembly.

FIG. 5b provides photographs of Western blot analysis of EV markers (CD9, Rap1B, FN1) and a negative marker (Calnexin) from EV samples isolated using the standard method and the assembly of the present disclosure.

FIG. 5c provides graphs of concentrations in particles per ml vs. size in nm for both control and the device of the present disclosure providing a nanoparticle tracking analysis (NTA) showing particle size distribution profiles of EVs isolated by the standard method and the device.

FIG. 5d provides transmission electron microscopy (TEM) photographs at different scales demonstrating typical EV morphology from the device-derived EV sample.

FIG. 5e is a bar graph showing the number of proteins identified in EV samples from control and device of the present disclosure by LC-MS/MS, with overlaps in top 100 EV proteins highlighted in darker shade), supporting the integrity and representativeness of EVs recovered from the device of the present disclosure.

FIG. 5f is a bar graph of Log2-transformed intensities of selected blood contaminant proteins for a control and the device of the present disclosure.

FIG. 5g is a graph of protein identification number vs. number of days ranging from 2 to 30 showing stability testing of dried blood EVs collected using the device of the present disclosure, where total protein identifications and overlaps with top 100 EV proteins are shown—data points are presented as mean±standard deviation (SD).

FIG. 6a is graph of PC2 vs. PC1 for various individuals providing PCA of proteomes from dried blood EV samples collected from five individuals, with triplicate samples per individual).

FIG. 6b is a graph showing p-values vs. fold-change in log-log which is a Volcano plot showing differential protein expression between bladder cancer patients and healthy controls.

FIG. 6c is a schematic of a timeline of a longitudinal study of tumor progression in a gastric cancer xenograft model, showing dried blood EVs collection and tumor development at indicated time points following cancer cell implantation).

FIG. 6d provides graphs of temporal expression trends of proteins from dried blood EVs over 42 days with two major clusters are shown, a downregulated cluster and an upregulated cluster), with enrichment of known GC-related GO terms in each cluster.

FIG. 7 is an exploded perspective view of a second embodiment of the biofluid card assembly, according to the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 15%, within 10%, within 5%, or within 1% of a stated value or of a stated limit of a range.

In the present disclosure, the term “substantially” can allow for a degree of variability in a value or range, for example, within 85%, within 90%, within 95%, or within 99% of a stated value or of a stated limit of a range.

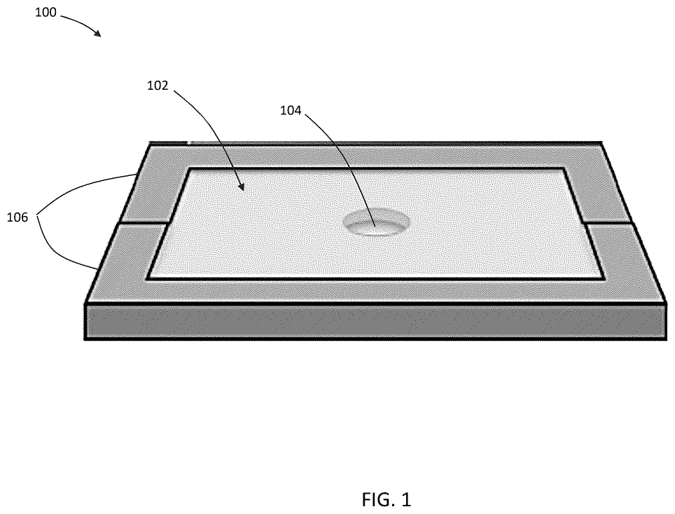

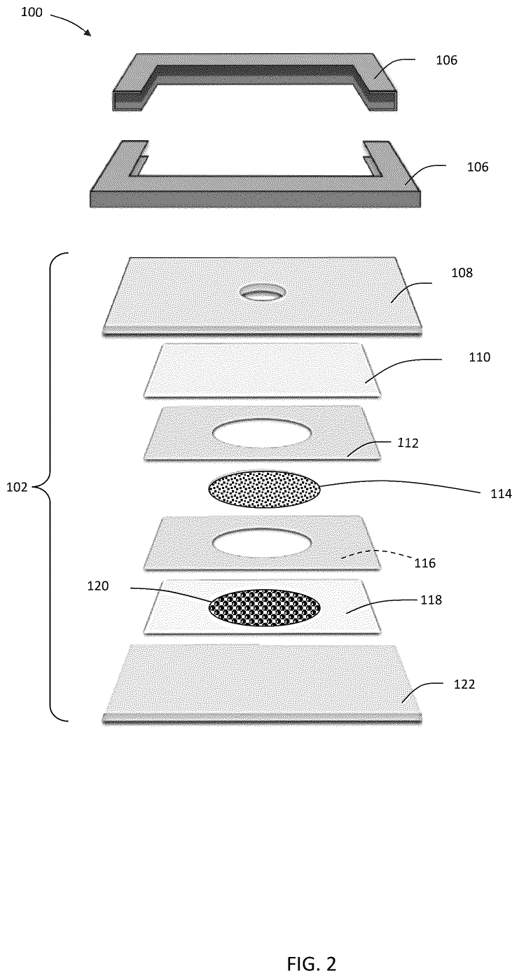

A novel robust system and method are disclosed herein that can effectively isolate extracellular vesicles in biofluids. Towards this end, the present disclosure provides a novel microsampling device that enables the isolation and analysis of extracellular vesicles (EVs) from dried capillary blood. By integrating membrane-based separation with EV-capturing beads, the device preserves intact EVs along with their protein and ribonucleic acid (RNA) cargoes. Comparative profiling revealed individual-specific molecular signatures. We also demonstrated broad applications in cancer marker detection, longitudinal tumor monitoring, and immunotherapy response assessment, offering a minimally invasive and scalable platform for decentralized diagnostics. Reference is made to FIG. 1 and FIGS. 2, which are a perspective view and an exploded view, respectively, of a biofluid card assembly 100 containing a biofluid card 102 having at least one well 104 and which biofluid card 102 is encased by fasteners 106, e.g., holding brackets but other fasteners within the knowledge of a person having ordinary skill in the art are withing the ambit of the present disclosure. The biofluid card assembly 100 is capable of transferring biofluid for on-site and off-site isolation of extracellular vesicles from the remaining bodies in the biofluid in dried form. Shown in FIGS. 1 and 2 is a biofluid card assembly 100 including a biofluid card 102 having at least one well in the form of a central opening for receiving biofluids held by the fasteners 106. It should be appreciated that more than one well 104, e.g., three wells (not shown), and supporting layers, see below, can be formed for concurrent collection of biofluid(s) in more than one well 104. For example, the layers described below can be formed in multiple segments to allow concurrent collection of multiple biofluids (e.g., blood, urine, saliva, on to one biofluid card assembly). FIG. 2 provides an exploded view of the biofluid card assembly 100. The biofluid card assembly 100 is capable of 1) receiving biofluids in liquid form, 2) isolating extracellular vesicles from other bodies, e.g., cells, present in the biofluids, 3) holding the isolated extracellular vesicles in and on an extracellular vesicle capture membrane while holding the remaining of the biofluid in and on a separation layer both in a dried form, and 4) allowing for easy transport of the isolated extracellular vesicles in and on the biofluid card assembly 100.

Referring to FIG. 2, the biofluid card assembly 100 includes the fasteners 106 formed, e.g., in the shape of halfmoon brackets, made out of a variety of potential materials, e.g., plastic, e.g., acrylic. It should be appreciated that the fasteners 106 is one example of a feature that is used to hold the various biofluid card assembly 100 layers, and other such features are possible, including various attachment features, e.g., other fasteners (not shown). The biofluid card assembly 100 includes the biofluid card 102. The biofluid card 102 is made of a number of elements, including a top lid 108 with at least one well 104 (a central opening), made of a variety of potential non-reacting materials, e.g., glass or acrylic. As discussed above, more than one well can be present with corresponding structures discussed below and about each of the wells. The biofluid card 102 next includes a biofluid separation membrane 110 where larger particles, e.g., blood cells, are initially filtered out by a biofluid separation membrane 110, which in case of blood has an asymmetric structure that captures the cellular components of whole blood, resulting in plasma with minimal cellular contamination. Therefore, if the biofluid is whole blood, the biofluid separation membrane 110 is a plasma separation membrane. Examples of plasma separation membranes include Whatman™ Blood Separators: VF2 and GF/DVA, D-23° C. Whole Blood Separation Media (from I.W. TREMONT CO., INC.), and Primecare™ Blood Separation Membranes (from Fortis Life Sciences®). It should be appreciated that while these examples are for plasma separation for whole blood, the biofluid separation membrane 110 is not limited to whole blood but other types of biofluids, e.g., urine and saliva, are within the ambit of the present disclosure. The biofluid card 102 next includes a first hydrophobic layer 112 with at least one central opening as part of the at least one well 104, made of a variety of materials, e.g., wax paper, responsible for directing remaining of the separated biofluid to progress to the next layers. The next layer in the biofluid card 102 is a filtration membrane 114, made from a variety of potential materials, e.g., polycarbonate, with tailored pore sizes, e.g., between about 0.2 μm to about 20 μm, for specific extracellular vesicle isolation applications. Particles or complexes larger than typical EV sizes (e.g., great than 400 nm), such as chylomicrons, are further removed by filtration membrane 114. Thus, bodies that were not separated at the biofluid separation membrane 110, but are of no concerns to extracellular vesicles are selectively separated at the filtration membrane 114. The next layer in the biofluid card 102 is an optional second hydrophobic layer 116 with at least one central opening as part of the at least one well 104, made of a variety of potential materials, e.g., wax paper, again responsible for guiding what should be primarily extracellular vesicles isolated in extracellular vesicles-separated biofluid to the next layer. With its low binding properties and consistent pore size, the hydrophilic membranes are utilized for liposome extrusion and EV filtration. The next layer of the biofluid card 102 is an extracellular vesicle capture membrane 118, made of a variety of potential materials, e.g., glass fiber membrane, with at least one extracellular vesicle capture agent 120 each disposed below and corresponding to the at least one well 104, e.g., chemical affinity agents to capture extracellular vesicles or selective antibody for a specific disease, e.g., cancer, located in a called out central region below the opening in the optional second hydrophobic layer 116. Examples of these affinity agents include: hydrophilic and lipophilic groups to capture EVs through chemical affinity (for all extracellular vesicles and not only disease extracellular vesicles), Membrane-penetrating peptides (e.g., octa-arginine R+8), antibodies for binding to extracellular vesicle surface markers (e.g., CD9, CD63) to capture all extracellular vesicles, antibodies such as anti-ASGR1 to target liver-derived extracellular vesicles, and anti-EGFR to target cancer-derived extracellular vesicles, avidin-coated surfaces bind to desthiobiotin-conjugated antibodies, with an affinity for extracellular vesicles, where the captured extracellular vesicles can then be released through biotin competition, e.g., dendrimer directly coated on the membrane, and other affinity agents known to a person having ordinary skill in the art. The chemical reagents or antibodies can be coupled to magnetic beads, e.g., silica-magnetic beads, polymer-coated magnetic beads, and other magnetic beads known to a person having ordinary skill in the art, for easy capturing later when the extracellular vesicle capture membrane 118 is processed to capture the isolated extracellular vesicles. The antibodies and affinity agents can be coupled to magnetic beads via chemical coupling reactions (e.g., amine-carboxylic acid coupling), antibody coupling reactions (e.g., protein A/G-coated beads), and other methods known to a person having ordinary skill in the art. The last layer is a matching lid layer (bottom lid 122), again made from a variety of potential materials, e.g., glass or plastic, e.g., acrylic. The EVs that pass through both membranes (biofluid separation membrane 110 and filtration membrane 114) are captured on an EV capturing membrane coated with extracellular vesicle capture agent 120 (e.g., having beads). The functional groups on the beads have a high affinity toward EVs and retain them on the coated area, while other molecules are carried by capillary flow to the uncoated areas. After the blood sample dries, the coated area is punched out and serves as a platform for EV extraction and detection.

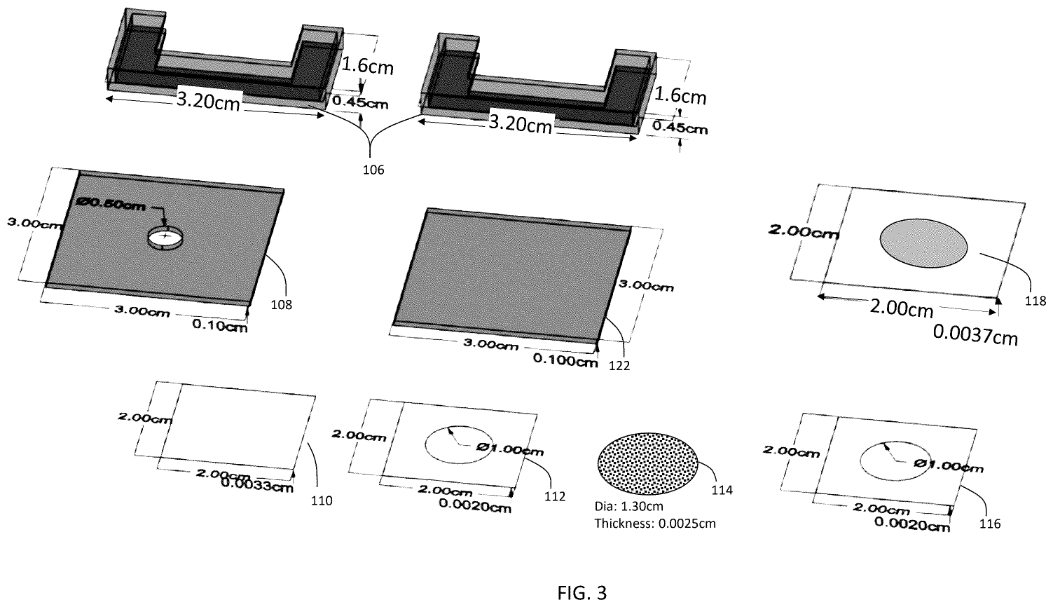

Referring to FIG. 3, example sizes of the different layers of the biofluid card 102 and the fasteners 106 are provided. It should be noted that these example sizes are provided only for reference, and no limitation is thereby intended by the inclusion of these sizes. The dimensions are provided in centimeters.

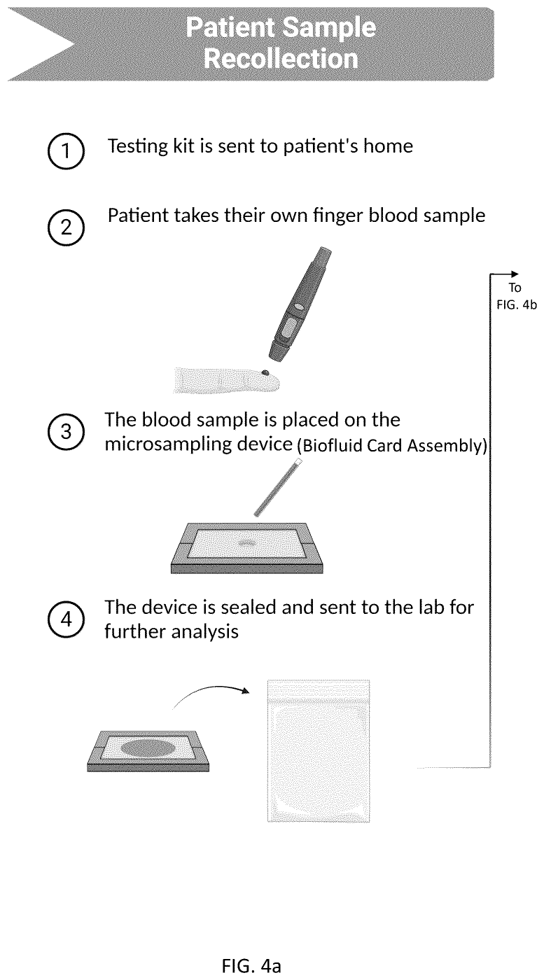

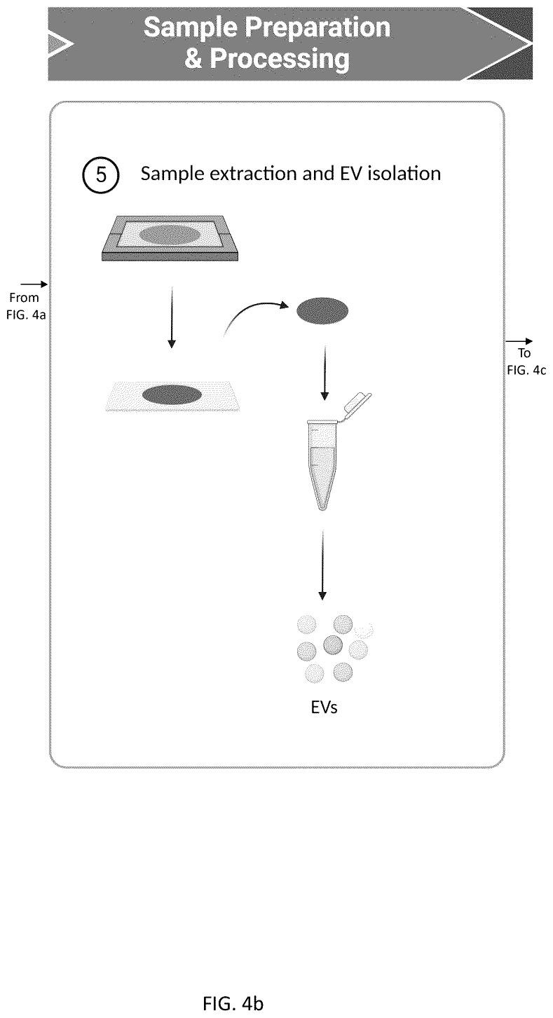

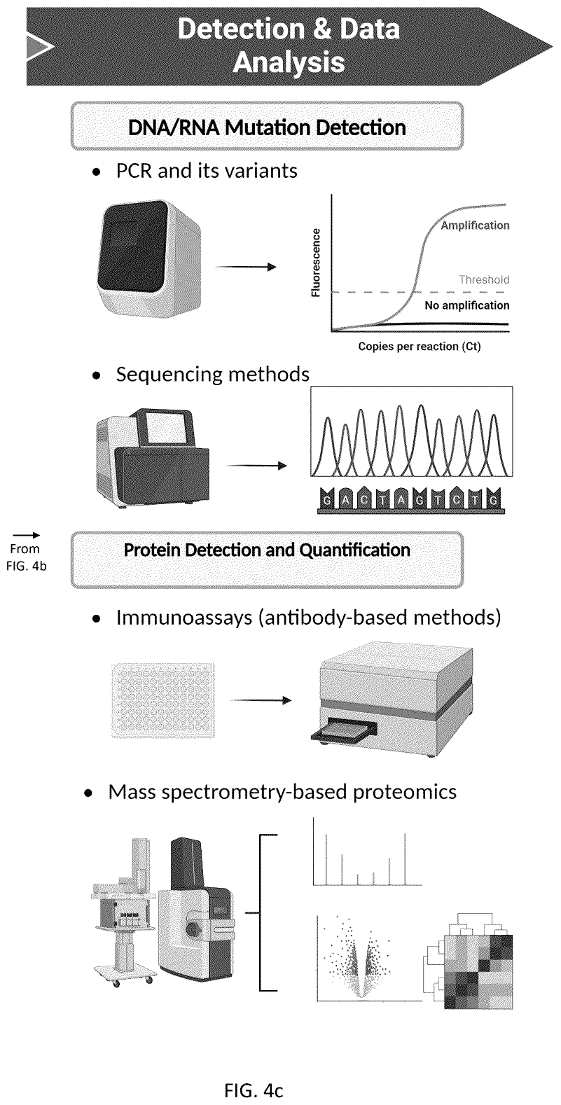

Referring to FIGS. 4a, 4b, and 4c, a sample biofluid collection and processing flowchart is shown expanding three drawing sheets, including sample collection, e.g., finger prick and deposition of whole blood onto the at least one well 104 of the biofluid card 102 of the biofluid card assembly 100, followed by packaging the entire biofluid card assembly 100 in which case a downstream laboratory disassembles the biofluid card assembly 100 to gain access to the extracellular vesicle capture membrane layer 118, or removing all layers, except for the extracellular vesicle capture membrane 118 and packing this layer, for later off-site or on-site processing and analysis. The flowchart also includes receiving the packaged sample (including the entire or partial biofluid card 102) and removing the extracellular vesicle capture membrane 118 and punching out the portion including an extracellular vesicle capture agent 120 which includes captured extracellular vesicles. The punched out extracellular vesicle capture agent 120 is then introduced to a vessel including a wetting agent. The wetted extracellular vesicle capture agent includes the desired extracellular vesicles which can be captured by a variety of methods, including a magnet, where magnetic beads were used, or by selective chemicals, where affinity molecules were used to capture diseased extracellular vesicles. A cleaving operation, e.g., Increasing pH to interrupt the interaction between affinity agents and extracellular vesicles, proteolytic cleavage reactions, and other methods known to a person having ordinary skill in the art can then be undertaken to cleave the extracellular vesicles from their capturing agents to thereby obtain the extracellular vesicles. Thereafter, the captured extracellular vesicles can be analyzed using known techniques discussed in reference to FIG. 4c, to establish presence of diseases in the captured extracellular vesicles.

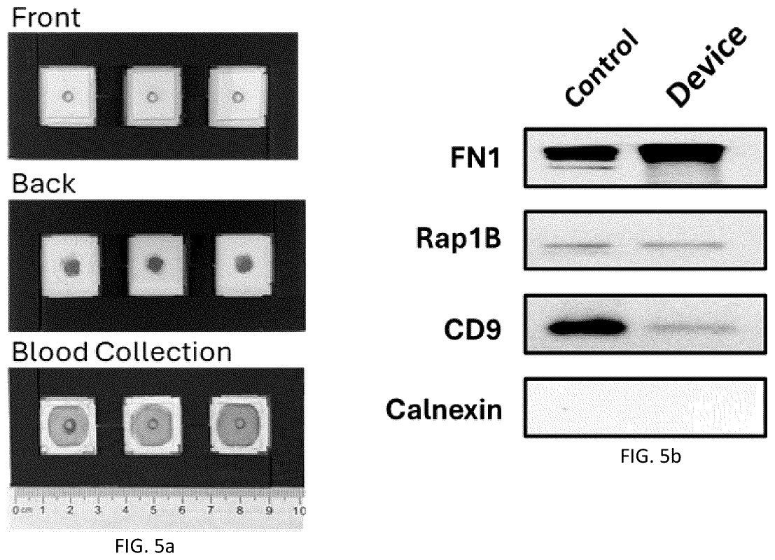

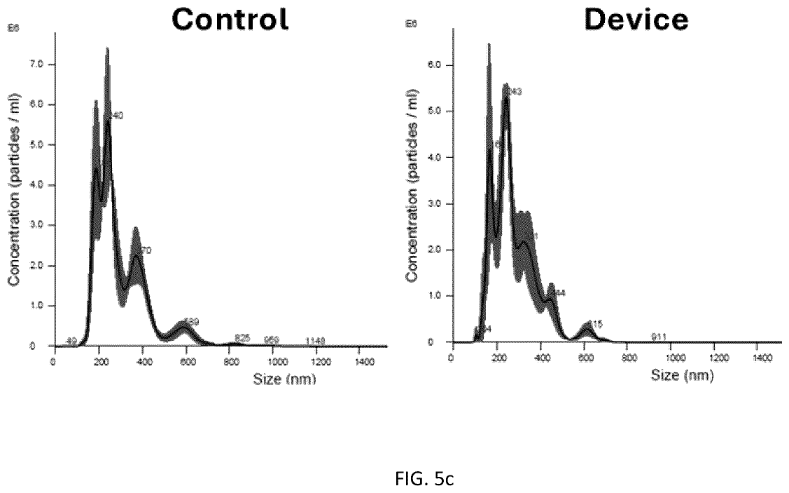

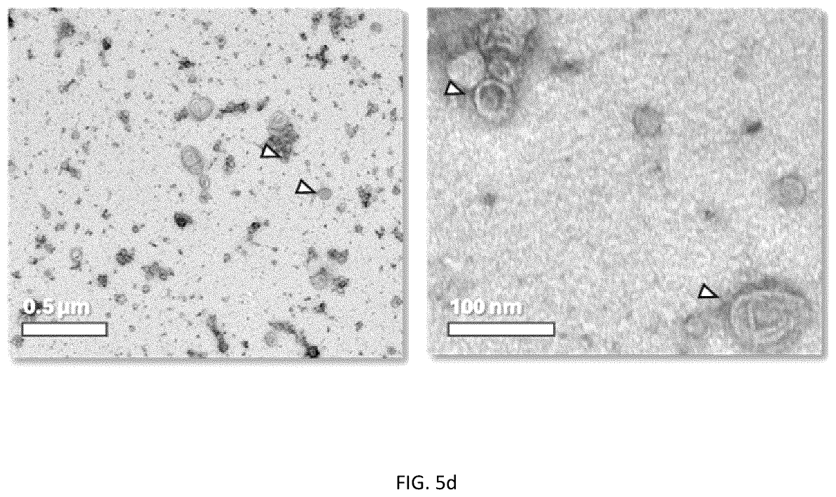

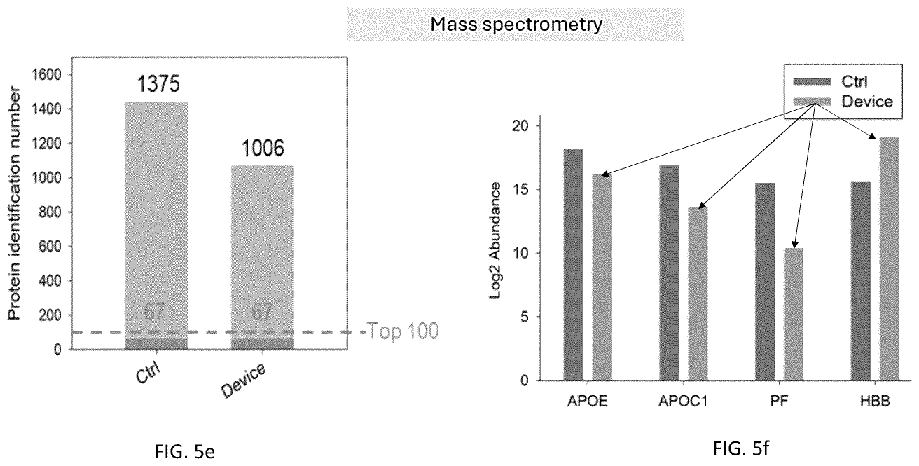

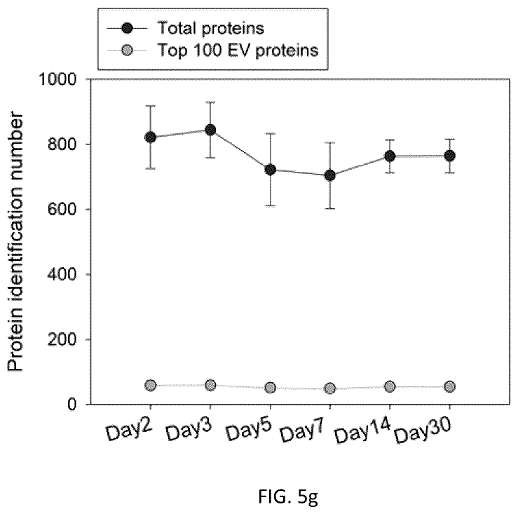

As part of the development of the disclosed system and methods, it was important to show that extracellular vesicles can be preserved in dried biofluids. To achieve better detection precision, the present disclosure provides a 3-spot prototype device for collecting triplicate blood samples (see FIG. 5a, which are photographs showing the front, back, and blood collection view of the three-spot device).

We first evaluated the feasibility of using the biofluid card assembly 100 to preserve and isolate EVs from whole blood. After collecting 50 μL of capillary blood onto the device and allowing the sample to dry and be stored at room temperature for two days, EVs were recovered and fully characterized. For comparison, EVs were also isolated from liquid capillary blood using a standard plasma EV isolation protocol. Three EV-associated proteins (CD9, FN1, and Rap1B) were detected from both standard methodology known in the art and the device of the present disclosure while the negative marker Calnexin, indicative of cellular contamination, was absent. Results of the detection are shown in FIG. 5b, which are photographs of Western blot analysis of EV markers (CD9, Rap1B, FN1) and a negative marker (Calnexin) from EV samples isolated using the standard method and the device.

The isolated EVs showed a size distribution of 50-400 nm (shown in FIG. 5c which are graphs of concentrations in particles per ml vs. size in nm for both control and the device providing a nanoparticle tracking analysis (NTA) showing particle size distribution profiles of EVs isolated by the standard method and the device), and transmission electron microscopy (TEM) confirmed their characteristic cup-shaped morphology (shown in FIG. 5d which are TEM photographs at different scales demonstrating typical EV morphology from the device-derived EV sample). Mass spectrometry (MS)-based proteomic profiling identified over 1,000 protein groups in both device and control samples, with high overlap among the top 100 EV proteins in the ExoCarta database (results shown in FIG. 5e which is a bar graph showing the number of proteins identified in EV samples from control and device by LC-MS/MS, with overlaps in top 100 EV proteins highlighted in darker shade), supporting the integrity and representativeness of EVs recovered from the device. Label-free quantification indicated contaminant proteins such as lipoproteins and platelet markers were less abundant in device-derived EVs, while EV-associated proteins were present at comparable levels to those in the control condition, as shown in FIG. 5f which is a bar graph of Log2-transformed intensities of selected blood contaminant proteins.

Given that EVs are reported to exhibit enhanced stability after lyophilization, we hypothesized that dried blood EVs collected with our device would retain stability and preserve molecular cargo integrity. Stability testing showed that EVs remained stable for up to 30 days at ambient temperature when stored with a desiccant (results are provided in FIG. 5g which is a graph of protein identification number vs. number of days ranging from 2 to 30 showing stability testing of dried blood EVs collected using the device, where total protein identifications and overlaps with top 100 EV proteins are shown-data points are presented as mean±SD). During this period, both total protein identifications and EV marker signals showed no significant decrease.

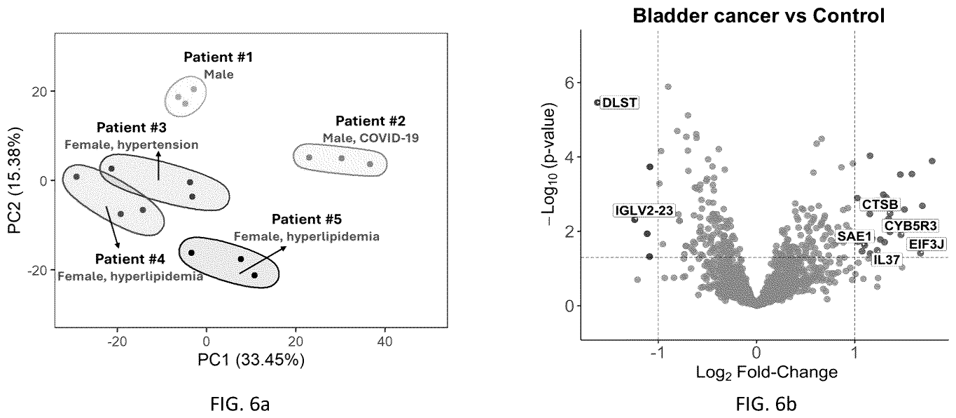

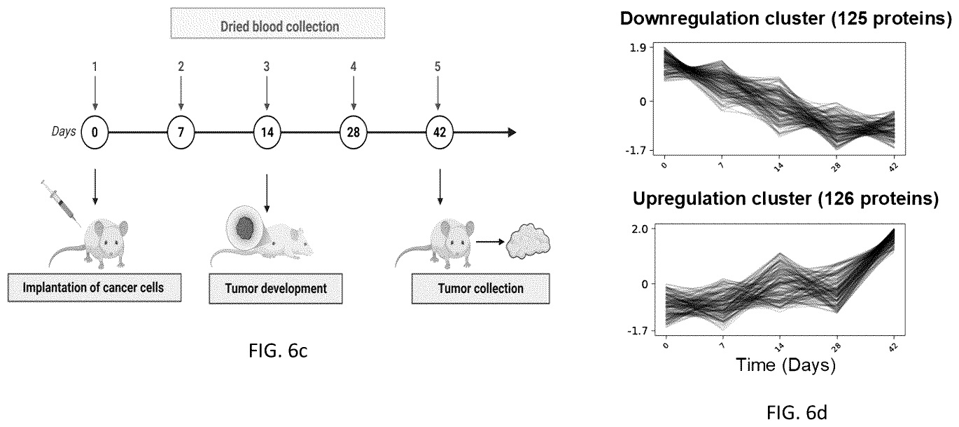

We next examined whether capillary blood-derived EVs collected from the device carry molecular information comparable to that of standard venous plasma EVs. To minimize inter-individual variability, paired capillary and venous blood samples were collected from the same individuals. MS-based proteomics revealed similar EV proteome coverage between both sample types. EV-related gene ontology (GO) terms were enriched from the identified proteins, further supporting the representativeness of the EV samples. Protein abundance profiles showed a high correlation between capillary and venous blood EVs for each individual. When comparing proteome profiles across individuals, both hierarchical clustering (HCA) and principal component analysis (PCA) showed that replicates from the same individual were well clustered and individual-specific clusters were observed. Further investigation of diagnostic histories indicated that the clusters with distinct protein signatures differentiated individual's physiological status (results are shown in FIG. 6a which is graph of PC2 vs. PC1 for various individuals providing PCA of proteomes from dried blood EV samples collected from five individuals, with triplicate samples per individual). In addition to proteomics, we also performed micro RNA (miRNA) detection on EVs isolated from both the device and venous plasma. Using an optimized RNA extraction protocol, known to a person having ordinary skill in the art, approximately 100 ng of total RNA was obtained from device-derived EVs. Several reported EV-associated miRNAs, including hsa-miR-222-3p16, hsa-miR-181a-5p17, and hsa-miR-100-5p18, were detected in both sample types, with comparable Ct values measured by qRT-PCR.

After confirming that EVs collected with the device exhibited individual-specific profiles, we next explored their potential for detecting cancer-associated protein signatures. As a proof-of-concept study, we collected and analyzed dried blood EVs from five bladder cancer (BC) patients and five non-cancer controls. Data-independent acquisition (DIA)-based proteomics quantified over 1,300 protein groups across all samples and replicates. PCA showed that EV proteome profiles from most cancer patients were distinct from those of the non-cancer group. Differential expression analysis identified several significantly regulated proteins in the BC group (with results shown in FIG. 6b which is a graph showing p-values vs. fold-change in log-log which is a Volcano plot showing differential protein expression between bladder cancer patients and healthy controls-different dots represent significantly upregulated and downregulated proteins, respectively (thresholds: adjusted p-value<0.05, |log₂fold−change|>1). Selected differentially expressed proteins are labeled), including known cancer-related proteins such as EIF3J, SAE1, and DLST. Notably, CTSB, an EV protein previously associated with BC prognosis, was upregulated in the BC group, further supporting the potential of dried blood EVs collected by our device for cancer marker detection.

Microsampling devices are particularly well-suited for longitudinal monitoring, as they enable frequent collection of small blood volumes. To evaluate this capability, we examined our device in a gastric cancer (GC) xenograft mouse model. Submandibular blood was collected from five mice at multiple time points during tumor development, and dried blood EVs were analyzed to monitor disease dynamics (with results shown in FIG. 6c which is a schematic of a timeline of a longitudinal study of tumor progression in a gastric cancer xenograft model, showing dried blood EVs collection and tumor development at indicated time points following cancer cell implantation). Co-expression clustering analysis of the time-series data revealed two distinct expression patterns (with results shown in FIG. 6d which provide graphs of temporal expression trends of proteins from dried blood EVs over 42 days with two major clusters are shown, a downregulated cluster and an upregulated cluster), with enrichment of known GC-related GO terms in each cluster. In the upregulated cluster, a marked increase in protein abundance was observed between days 28 and 42, corresponding to the observed tumor growth stage. Proteins with increased abundance showed strong correlation with tumor size in individual mice. Known cancer-associated proteins, including MTOR, BRAF, and PIK3CB, were identified in the upregulated cluster. To validate these findings, we also profiled EVs from implanted SNU719 cells and resected tumors from the xenograft model. A high degree of protein overlap was observed between dried blood EVs and cancer cell-/tumor-derived EVs, with most proteins in the clusters also detected in the cancer EV datasets.

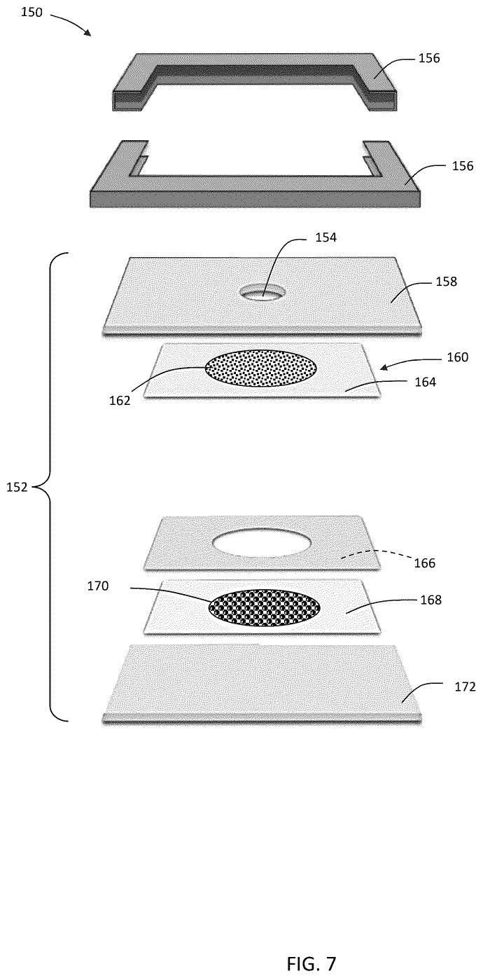

While in FIG. 2 several layers are shown for filtration and directing of EVs out of biofluids onto the at least one extracellular vesicle capture agent 120, other embodiments of the biofluid card assembly are within the ambit of the present disclosure. For example, referring to FIG. 7, a biofluid card assembly 150 is shown in which some of the layers shown in the biofluid card assembly 100 of FIG. 2 are combined or eliminated. The biofluid card assembly 150 includes a biofluid card 152 having at least one well 154 and which biofluid card 152 is encased in fasteners 156. As provided above the fasteners 156 can be brackets shaped in halfmoons or other types of fasteners known to a person having ordinary skill in the art. The biofluid card assembly 100 is capable of transferring dried biofluids for on-site and off-site isolation of extracellular vesicles from the remaining bodies in the dried form of the biofluid. It should be appreciated that more than one well 154, e.g., three wells (not shown), and supporting layers, see below, can be formed for concurrent collection of biofluid(s) in more than one well 154. For example, the layers described below can be formed in multiple segments to allow concurrent collection of multiple biofluids (e.g., blood, urine, saliva, on to one biofluid card assembly 150). FIG. 7 provides an exploded view of the biofluid card assembly 150. The biofluid card assembly 150 is capable of 1) receiving biofluids in liquid form, 2) isolating extracellular vesicles from other bodies, e.g., cells, present in the biofluids, 3) holding the isolated extracellular vesicles in and on an extracellular vesicle capture membrane while holding the remaining of the biofluid in and on a separation layer both in a dried form, and 4) allowing for easy transport of the isolated extracellular vesicles in and on the biofluid card assembly 150.

Referring to FIG. 7, the biofluid card assembly 150 includes fasteners 156 formed, e.g., in the shape of halfmoons, made out of a variety of potential materials, e.g., plastic, e.g., acrylic. The biofluid card assembly 150 includes the biofluid card 152. The biofluid card 152 is made of a number of elements, including a top lid 158 with at least one well 154 (a central opening), made of a variety of potential non-reacting materials, e.g., glass or acrylic. As discussed above, more than one well can be present with corresponding structures discussed below. The biofluid card 152 next includes a biofluid separation membrane assembly 160 where EVs are filtered and directed by the biofluid separation membrane assembly 160. The biofluid separation membrane assembly 160 includes two components: 1) a biofluid separation membrane 162 and a hydrophobic component 164. The Examples of plasma separation membranes 162 include Whatman™ Blood Separators: VF2 and GF/DVA, D-23 Whole Blood Separation Media (from I.W. TREMONT CO., INC.), and Primecare™ Blood Separation Membranes (from Fortis Life Sciences®). It should be appreciated that while these examples are for plasma separation for whole blood, the biofluid separation membrane 162 is not limited to whole blood but other types of biofluids, e.g., urine and saliva, are within the ambit of the present disclosure. The biofluid separation membrane 162 is a porous structure with a pore size of between about 0.2 μm to about 20 μm. The hydrophobic component 164 may be made of a variety of materials, e.g., wax paper, responsible for directing the separated components by the biofluid separation membrane 162. It should be appreciated that biofluid separation membrane assembly 160 in FIG. 7 combines several layers shown in the biofluid card 102 shown in FIG. 2. Specifically, the first hydrophobic layer 112 is combined with biofluid separation membrane 110 as the biofluid separation membrane assembly 160. The next layer in the biofluid card 152 is an optional hydrophobic layer 166 with at least one central opening as part of the at least one well 154, made of a variety of potential materials, e.g., wax paper, again responsible for guiding what should be primarily extracellular vesicles isolated in extracellular vesicles-separated biofluid to the next layer. With its low binding properties and consistent pore size, the hydrophilic membranes are utilized for liposome extrusion and EV filtration. The next layer of the biofluid card 152 is an extracellular vesicle capture membrane 168, made of a variety of potential materials, e.g., glass fiber membrane, with at least one extracellular vesicle capture agent 170 each disposed below and corresponding to the at least one well 154, e.g., chemical affinity agents to capture extracellular vesicles or selective antibody for a specific disease, e.g., cancer, located in a called out central region below the opening in the optional hydrophobic layer 166. Examples of these affinity agents include: hydrophilic and lipophilic groups to capture EVs through chemical affinity (for all extracellular vesicles and not only disease extracellular vesicles), Membrane-penetrating peptides (e.g., octa-arginine R+8), antibodies for binding to extracellular vesicle surface markers (e.g., CD9, CD63) to capture all extracellular vesicles, antibodies such as anti-ASGR1 to target liver-derived extracellular vesicles, and anti-EGFR to target cancer-derived extracellular vesicles, avidin-coated surfaces bind to desthiobiotin-conjugated antibodies, with an affinity for extracellular vesicles, where the captured extracellular vesicles can then be released through biotin competition, e.g., dendrimer directly coated on the membrane, and other affinity agents known to a person having ordinary skill in the art. The chemical reagents or antibodies can be coupled to magnetic beads, e.g., silica-magnetic beads, polymer-coated magnetic beads, and other magnetic beads known to a person having ordinary skill in the art, for easy capturing later when the extracellular vesicle capture membrane 168 is processed to capture the isolated extracellular vesicles. The antibodies and affinity agents can be coupled to magnetic beads via chemical coupling reactions (e.g., amine-carboxylic acid coupling), antibody coupling reactions (e.g., protein A/G-coated beads), and other methods known to a person having ordinary skill in the art. The last layer is a matching lid layer (bottom lid 172), again made from a variety of potential materials, e.g., glass or plastic, e.g., acrylic. The EVs that pass through both membranes (biofluid separation membrane assembly 160) are captured on an EV capturing membrane coated with extracellular vesicle capture agent 170 (e.g., having beads). The functional groups on the beads have a high affinity toward EVs and retain them on the coated area, while other molecules are carried by capillary flow to the uncoated areas. After the blood sample dries, the coated area is punched out and serves as a platform for EV extraction and detection.

It should be appreciated that the extracellular vesicle capture membrane 118 (which may be multiple such membranes) in FIG. 2 or the extracellular vesicle capture membrane 168 (which may be multiple such membranes) in FIG. 7 each is made of one of a glass fiber material, cellulose, polyethersulfone, polycarbonate, or a combination thereof.

Those having ordinary skill in the art will recognize that numerous modifications can be made to the specific implementations described above. The implementations should not be limited to the particular limitations described. Other implementations may be possible.

1. A biofluid card assembly for isolating extracellular vesicles present in biofluids, comprising:
a biofluid card having a plurality of layers; and
a fastener configured to hold one or more of the plurality of layers of the biofluid card, the biofluid card, comprising:
a top lid with at least one opening formed therein configured to receive at least one biofluid sample including one or more principal components and extracellular vesicles present therein;
a biofluid separation membrane assembly disposed adjacent the top lid and configured to separate and direct the extracellular vesicles;
at least one extracellular vesicle capture membrane having at least one extracellular vesicle capture agent formed thereon, each disposed below or embedded in the at least one extracellular vesicle capture membrane and corresponding to the at least one first opening and adjacent the biofluid separation membrane assembly and configured to receive the extracellular vesicles, wherein each of the at least one extracellular vesicle capture agent includes a binding agent configured to bind to the extracellular vesicle having predetermined binding sites; and
a bottom lid disposed adjacent the at least one extracellular vesicle capture membrane.

2. The biofluid card assembly of claim 1, wherein the biofluid separation membrane assembly comprises:
at least one filtration membrane disposed adjacent each of the at least one opening and configured to receive the at least one biofluid sample, the at least one filtration membrane configured to filter the extracellular vesicles out of the at least one biofluid sample; and
at least one hydrophobic layer portion adjacent the at least one filtration membrane configured to direct the extracellular vesicles through the at least one filtration membrane.

3. The biofluid card assembly of claim 1, wherein the top lid and the bottom lid are made of glass or plastic.

4. The biofluid card assembly of claim 2, wherein the at least one hydrophobic layer is made of wax paper.

5. The biofluid card assembly of claim 2, wherein the at least one filtration membrane is porous, wherein the filtration membrane has a pore size of between about 0.2 μm to about 20 μm.

6. The biofluid card assembly of claim 5, wherein the at least one opening is one opening; the at least one biofluid sample is one biofluid; the at least one filtration membrane is one filtration membrane; and the at least one extracellular vesicle capture membrane is one extracellular vesicle capture membrane corresponding to the one opening, the one biofluid, and the one filtration membrane.

7. The biofluid card assembly of claim 5, wherein the at least one opening is two openings; the at least one biofluid sample is two biofluids; the at least one filtration membrane is two filtration membranes; and the at least one extracellular vesicle capture membrane is two extracellular vesicle capture membranes corresponding to the two openings, the two biofluids, and the two filtration membranes.

8. The biofluid card assembly of claim 5, wherein the at least one opening is three openings; the at least one biofluid sample is three biofluids; the at least one filtration membrane is three filtration membranes; and the at least one extracellular vesicle capture membrane is three extracellular vesicle capture membranes corresponding to the three openings, the three biofluids, and the three filtration membranes.

9. The biofluid card assembly of claim 1, wherein the extracellular vesicle capture membrane is made of one of a glass fiber material, cellulose, polyethersulfone, polycarbonate, or a combination thereof.

10. The biofluid card assembly of claim 1, wherein the extracellular vesicle capture agent includes a) solid phase beads made of silica, magnetic beads, or combinations thereof, or b) polymers coupled to extracellular vesicle binding agents including i) antibodies configured to recognize extracellular vesicle markers or extracellular vesicle surface proteins, or ii) chemical affinity reagents including lipid-like and membrane-penetrating molecules.

11. A method for isolating extracellular vesicles present in whole blood, comprising:
inputting a whole blood sample including one or more principal components and extracellular vesicles present therein into a biofluid card assembly;
receiving the whole blood sample via a top lid of the biofluid card assembly with at least one opening formed therein,
separating the extracellular vesicles via a biofluid separation membrane assembly disposed below and corresponding to the at least one opening and configured to separate the one or more principal components of the whole blood from remaining components of the whole blood including extracellular vesicles; and
capturing the extracellular vesicle via at least one extracellular vesicle capture membrane having at least one extracellular vesicle capture agent formed thereon, each disposed below or embedded in the at least one extracellular vesicle capture membrane and corresponding to the at least one opening and adjacent the biofluid separation membrane assembly on one side and adjacent a bottom lid on a second side, wherein each of the at least one extracellular vesicle capture agent includes binding agent configured to bind to the extracellular vesicle having predetermined binding sites.

12. The method of claim 11, wherein the biofluid separation membrane assembly comprises:
at least one filtration membrane disposed adjacent each of the at least one opening and configured to receive whole blood, the at least one filtration membrane configured to filter the extracellular vesicles out of the whole blood; and
at least one hydrophobic layer portion adjacent the at least one filtration membrane configured to direct the extracellular vesicles through the at least one filtration membrane.

13. The method of claim 11, wherein the top lid and the bottom lid are made of glass or plastic.

14. The method of claim 12, wherein the at least one hydrophobic layer is made of wax paper.

15. The method of claim 12, wherein the at least one filtration membrane is porous, wherein the filtration membrane has a between about 0.2 μm to about 20 μm.

16. The method of claim 15, wherein the at least one opening is one opening; the at least one filtration membrane is one filtration membrane; and the at least one extracellular vesicle capture membrane is one extracellular vesicle capture membrane corresponding to the one opening, and the one filtration membrane.

17. The method of claim 15, wherein the at least one opening is two openings; the at least one filtration membrane is two filtration membranes; and the at least one extracellular vesicle capture membrane is two extracellular vesicle capture membranes corresponding to the two openings, and the two filtration membranes.

18. The method of claim 15, wherein the at least one opening is three openings; the at least one filtration membrane is three filtration membranes; and the at least one extracellular vesicle capture membrane is three extracellular vesicle capture membranes corresponding to the three openings, and the three filtration membranes.

19. The method of claim 11, wherein the extracellular vesicle capture membrane is made of one of a glass fiber material, cellulose, polyethersulfone, polycarbonate, or a combination thereof.

20. The method of claim 11, wherein the extracellular vesicle capture agent includes a) solid phase beads made of silica, magnetic beads, or combinations thereof, or b) polymers coupled to extracellular vesicle binding agents including i) antibodies configured to recognize extracellular vesicle markers or extracellular vesicle surface proteins, or ii) chemical affinity reagents including lipid-like and membrane-penetrating molecules.
